(19) United States
(12) Patent Application Publication
(10) Pub. No.: US 2025/0274536 A1
(43) Pub. Date: Aug. 28, 2025

(54) SERVICE PROCESSING METHOD AND SYSTEM, STORAGE MEDIUM, AND ELECTRONIC DEVICE

(71) Applicant: Ruijie Networks Co., Ltd., Fuzhou (Fujian) (CN)

(72) Inventors: Jiguo HE, Fuzhou (CN); Xuewei WANG, Fuzhou (CN)

(21) Appl. No.: 19/191,401

(22) Filed: Apr. 28, 2025

Related U.S. Application Data
(63) Continuation of application No. PCT/CN2023/125882, filed on Oct. 23, 2023.

(30) Foreign Application Priority Data
Oct. 28, 2022 (CN) 202211338891.2
Feb. 28, 2023 (CN) 202310180351.4
Sep. 26, 2023 (WO) PCT/CN2023/121756

(51) Int. Cl. H04L 67/63; H04L 45/02

(52) U.S. Cl. CPC H04L 67/63; H04L 45/02

(57) ABSTRACT

This application discloses a service processing method applied to a first routing device. The method includes: receiving a first data packet, where the first data packet carries identification information corresponding to a target service requested by a user; determining a target service instance corresponding to the target service; and sending a second data packet to a second routing device corresponding to the target service instance, where the second data packet is determined based on the first data packet, and the second data packet carries identification information corresponding to the target service instance. This application further discloses a service processing system, a storage medium, and an electronic device.

### CROSS-REFERENCE TO RELATED APPLICATIONS

This application is a continuation application of International Application No. PCT/CN2023/125882, filed on Oct. 23, 2023, which claims priority to Chinese Patent Application No. 202211338891.2, filed with the China National Intellectual Property Administration on Oct. 28, 2022 and entitled “ROUTING METHOD AND APPARATUS”, Chinese Patent Application No. 202310180351.4, filed with the China National Intellectual Property Administration on Feb. 28, 2023, and entitled “SERVICE PROCESSING METHOD AND APPARATUS IN COMPUTE FIRST NETWORKING, DEVICE, AND MEDIUM”, and International Patent Application No. PCT/CN2023/121756, filed with the China National Intellectual Property Administration on Sep. 26, 2023 and entitled “ROUTING METHOD AND SYSTEM, STORAGE MEDIUM, AND ELECTRONIC DEVICE”, all of which are incorporated herein by reference in their entireties.

### TECHNICAL FIELD

This application relates to the field of communication technologies, and in particular, to a service processing method and system, a storage medium, and an electronic device.

### BACKGROUND

As the information society enters a new stage of intelligence, in addition to interconnection and interworking of devices, more service requirements are gradually emerging, and computing capabilities of devices and big data resources have become crucial to a new information infrastructure.

Compute first networking is a new information infrastructure that allocates and flexibly schedules resources among network devices based on service requirements. Currently, compute first networking largely uses a distributed architecture scheme based on dynamic anycast (Dynamic Anycast, Dyncast). Compute first networking dynamic anycast (Compute First Networking Dynamic Anycast, CFN-Dyncast) is a distributed technology that schedules, based on computing power load and network status of a plurality of servers such as mobile edge computing (Mobile Edge Computing, MEC) sites, a user requirement to an optimal server such as a MEC site. Because different MEC sites have different computing power load and network status at a same time point, how to schedule a user requirement to an optimal MEC site is a core problem to be solved in the compute first networking technology.

In the current compute first networking, a routing decision is usually made between compute first networking routers (Compute First Networking Router, CFN Router) based on identification information corresponding to a service requested by a user, such as service identification information (Service ID, SID). In other words, routing information and computing power information of a server (such as a MEC site) corresponding to the service identification information are transmitted to provide the user with an optimal server, such as an optimal MEC site. In a process of selecting an optimal MEC site, it is usually necessary to look up computing power and routing tables on a plurality of routers on a packet transmission path respectively, determine a MEC site with optimal computing power and network performance, and forward a packet to a next hop.

### SUMMARY

Exemplary embodiments of this application provide a service processing method and system, a storage medium, and an electronic device to improve stability of the service processing system.

According to a first aspect, an embodiment of this application provides a service processing method, including: receiving, by a first router, a first data packet, where the first data packet carries a service identifier SID; determining, based on the SID carried in the first data packet and computing power and routing information, a target binding identifier (Binding ID, BID) corresponding to the SID, where a MEC site corresponding to the target BID is a target MEC site; and sending, by the first router, a second data packet to a second router corresponding to the target MEC site, where the second data packet is determined based on the first data packet, and the second data packet carries the target BID.

According to this method, the target MEC site can be determined based on the SID in the first data packet and the computing power and routing information, thereby avoiding a routing loop problem and improving stability of a service processing system.

In a possible implementation, before determining, based on the service identifier SID carried in the first data packet and the computing power and routing information, the target BID corresponding to the SID, the first router may further receive the computing power and routing information sent by the second router, where the computing power and routing information is used to indicate a correspondence between the SID and one or more BIDs, and the one or more BIDs include the target BID.

By using this method, the first router can efficiently determine the target BID based on the SID in the first data packet and the computing power and routing information.

In a possible implementation, in a case that the SID corresponds to a plurality of BIDs, the determining, based on the service identifier SID and the computing power and routing information, the target binding identifier BID corresponding to the SID includes: determining, based on the service identifier SID and the computing power and routing information, the target MEC site from a plurality of MEC sites corresponding to the plurality of BIDs, where the computing power and routing information includes computing power information and routing information; and determining that the BID corresponding to the target MEC site is the target BID corresponding to the SID.

In a possible implementation, after the determining, based on the service identifier SID and the computing power and routing information, the target binding identifier BID corresponding to the SID, the method further includes: replacing the SID in the first data packet with the target BID.

By using this method, the first router can generate, based on the first data packet, the second data packet carrying the target BID.

In a possible implementation, the first data packet includes data and tunnel information.

According to a second aspect, an embodiment of this application further provides a service processing method, including:
receiving, by a second router, a second data packet sent by a first router, where the second data packet is determined by the first router based on a received first data packet, the second data packet carries a target BID, and the target BID is determined based on a SID carried in the first data packet and computing power and routing information; and sending, by the second router, a third data packet to a target MEC site corresponding to the target BID, where the third data packet is determined based on the second data packet.

In a possible implementation, before receiving the second data packet sent by the first router, the second router sends the computing power and routing information to the first router, where the computing power and routing information is used to indicate a correspondence between the SID and one or more BIDs, and the one or more BIDs include the target BID.

By using this method, the first router can quickly determine the target BID based on the SID in the first data packet and the computing power and routing information.

In a possible implementation, in a case that the SID corresponds to a plurality of BIDs, the sending, by the second router, the third data packet to the target MEC site corresponding to the target BID includes: determining, by the second router based on the target BID, the target MEC site corresponding to the target BID from a plurality of MEC sites corresponding to the plurality of BIDs; and sending, by the second router, the third data packet to the target MEC site.

According to this method, the second router determines the target MEC site based on the target BID carried in the second data packet. Because one BID corresponds to one MEC site, the second router can be connected to the plurality of MEC sites. Therefore, in a case that a quantity of MEC sites is fixed, a quantity of second routers is reduced, and costs are reduced, and this better aligns with a practical application scenario of compute first networking.

In a possible implementation, the second data packet includes tunnel information, and before the sending the third data packet to the target MEC site corresponding to the target BID, the method further includes: decapsulating the tunnel information in the second data packet; and using the decapsulated packet as the third data packet.

According to a third aspect, an embodiment of this application provides a service processing apparatus, including: a communication module, configured to receive a first data packet, where the first data packet carries a service identifier SID; and a processing module, configured to determine, based on the service identifier SID carried in the first data packet and computing power and routing information, a target binding identifier BID corresponding to the SID, where a MEC site corresponding to the target BID is a target MEC site, where the communication module is further configured to send a second data packet to a second router corresponding to the target MEC site, where the second data packet is determined based on the first data packet, and the second data packet carries the target BID.

In a possible implementation, in a case that the SID corresponds to a plurality of BIDs, the processing module is further configured to determine, based on the service identifier SID and the computing power and routing information, the target MEC site from a plurality of MEC sites corresponding to the plurality of BIDs, where the computing power and routing information includes computing power information and routing information; and determine that the BID corresponding to the target MEC site is the target BID corresponding to the SID.

In a possible implementation, before determining, based on the service identifier SID carried in the first data packet and the computing power and routing information, the target binding identifier BID corresponding to the SID, the communication module is further configured to receive the computing power and routing information sent by the second router, where the computing power and routing information is used to indicate a correspondence between the SID and one or more BIDs, and the one or more BIDs include the target BID.

In a possible implementation, after determining, based on the service identifier SID and the computing power and routing information, the target binding identifier BID corresponding to the SID, the processing module is further configured to replace the SID in the first data packet with the target BID.

In a possible implementation, the first data packet includes data and tunnel information.

According to a fourth aspect, an embodiment of this application further provides a service processing apparatus, including a communication module, configured to receive a second data packet sent by a first router, where the second data packet is determined by the first router based on a received first data packet, the second data packet carries a target BID, and the target BID is determined based on a SID carried in the first data packet and computing power and routing information, where the communication module is further configured to send a third data packet to a target MEC site corresponding to the target BID, where the third data packet is determined based on the second data packet.

In a possible implementation, before receiving the second data packet sent by the first router, the communication module is further configured to send the computing power and routing information to the first router, where the computing power and routing information includes a correspondence between the SID and one or more BIDs, and the one or more BIDs include the target BID.

In a possible implementation, the service processing apparatus further includes a processing module. In a case that the SID corresponds to a plurality of BIDs, the processing module is configured to determine, based on the target BID, the target MEC site corresponding to the target BID from a plurality of MEC sites; and the communication module is configured to send the third data packet to the target MEC site.

In a possible implementation, the second data packet includes tunnel information, and the processing module is further configured to decapsulate the tunnel information in the second data packet; and use the decapsulated packet as the third data packet.

According to a fifth aspect, an embodiment of this application further provides a service processing method, applied to an ingress routing device. The method includes: determining a target service instance corresponding to a target service requested by a client, where the target service is provided by a compute first networking; encapsulating identification information of the target service instance into a data packet from the client; and sending the data packet to an egress routing device corresponding to the target service instance, so that the target service instance for the egress routing device processes the data packet.

In this embodiment, after the target service requested by the customer is obtained, the target service instance for service processing of the customer is determined based on the target service. Then the identification information of the target service instance is added to the data packet and sent to the egress routing device corresponding to the target service instance. In the foregoing procedure, only the ingress routing device needs to make a decision. Based on the identification information carried in the packet, the egress routing device may directly instruct the service instance to process the data packet. In this way, a possible loop problem arising from decisions simultaneously made by the ingress routing device and the egress routing device is solved. Moreover, because the egress routing device does not need to make a decision, the egress routing device does not need to maintain a session entry that carries a mapping between a service flow and a server. Therefore, forwarding resource requirements of the egress routing device can be effectively reduced.

In a possible implementation, the encapsulating the identification information of the target service instance into the data packet from the client includes: adding the identification information of the target service instance to an IPv6 extension header of the data packet.

In a possible implementation, the IPv6 extension header of the data packet includes a destination options header, and the destination options header includes option content carrying the identification information.

In a possible implementation, the IPv6 extension header of the data packet includes a segment routing header, the segment routing header includes a type-length-value TLV, and the TLV includes the identification information of the target service instance.

In a possible implementation, the IPv6 extension header of the data packet includes a segment routing header, the segment routing header includes a segment list, and the identification information is located at an end of a path indicated by the segment list.

In a possible implementation, the compute first networking includes one or more routing devices, each routing device is connected to one or more servers, and the one or more servers are configured to provide the target service; and the determining the target service instance corresponding to the target service requested by the client includes: obtaining computing power resource information of servers corresponding to the one or more routing devices and network parameter information of the one or more routing devices, where the network parameter information includes at least a network delay and bandwidth of the routing device; and determining, based on the computing power resource information and the network parameter information, the target service instance corresponding to the target service from a plurality of service instances corresponding to the one or more routing devices.

In this embodiment of this application, after obtaining the target service requested by the customer, the ingress routing device determines, based on the target service, the target service instance for service processing of the customer. Then the identification information of the target service instance is added to the data packet and sent to the egress routing device corresponding to the target service instance. In the foregoing procedure, only the ingress routing device needs to make a decision. Based on the identification information carried in the packet, the egress routing device may directly instruct the service instance to process the data packet. In this way, a possible loop problem arising from decisions simultaneously made by the ingress routing device and the egress routing device is solved. Moreover, because the egress routing device does not need to make a decision, the egress routing device does not need to maintain a session entry that carries a mapping between a service flow and a server. Therefore, forwarding resource requirements of the egress routing device can be effectively reduced.

According to a sixth aspect, an embodiment of this application further provides a service processing method, applied to an egress routing device. The method includes: receiving a data packet sent by an ingress routing device, and parsing the data packet to obtain identification information of a target service instance; and determining, based on the identification information, an address indicated in the data packet, and sending the data packet to the target service instance corresponding to the indicated address, so that the target service instance processes the data packet.

In a possible implementation, the identification information is obtained through parsing in one of the following manners: parsing a destination options header of the data packet to obtain option content carried by the destination options header, and determining the identification information based on the option content; parsing a segment routing header of the data packet to obtain a type-length-value of the segment routing header, and determining the identification information based on the type-length-value; or parsing a segment routing header of the data packet to obtain a segment list of the segment routing header, and determining the identification information based on a path indicated by the segment list.

In this embodiment of this application, after the egress routing device receives the data packet sent by the ingress routing device, the egress routing device parses the data packet to obtain the identification information of the target service instance. Then the egress routing device determines, based on the identification information, the address indicated in the data packet, and sends the data packet to the target service instance corresponding to the indicated address, to instruct the target service instance to perform service processing for a customer. In the foregoing procedure, based on the identification information carried in the packet, the egress routing device may directly instruct the service instance to process the data packet, without making a routing decision. In this way, a possible loop problem arising from decisions simultaneously made by the ingress routing device and the egress routing device is solved. Moreover, because the egress routing device does not need to make a decision, the egress routing device does not need to maintain a session entry that carries a mapping between a service flow and a server. Therefore, forwarding resource requirements of the egress routing device can be effectively reduced.

According to a seventh aspect, an embodiment of this application further provides a service processing apparatus. The apparatus includes: an instance selection module, configured to determine a target service instance corresponding to a target service requested by a client; an information encapsulation module, configured to encapsulate identification information of the target service instance into a data packet from the client; and a packet forwarding module, configured to send the data packet to an egress routing device corresponding to the target service instance, so that the target service instance for the egress routing device processes the data packet.

In a possible implementation, the information encapsulation module is configured to add the identification information of the target service instance to an IPv6 extension header of the data packet.

In a possible implementation, the IPv6 extension header of the data packet includes a destination options header, and the destination options header includes option content carrying the identification information.

In a possible implementation, the IPv6 extension header of the data packet includes a segment routing header, the segment routing header includes a type-length-value TLV, and the TLV includes the identification information of the target service instance.

In a possible implementation, the IPv6 extension header of the data packet includes a segment routing header, the segment routing header includes a segment list, and the identification information is located at an end of a path indicated by the segment list.

In a possible implementation, compute first networking includes one or more routing devices, each routing device is connected to one or more servers, and the one or more servers are configured to provide the target service; and the instance selection module is configured to obtain computing power resource information of servers corresponding to the one or more routing devices in the compute first networking and network parameter information of the one or more routing devices, where the network parameter information includes at least a network delay and bandwidth of the routing device; and select, based on the computing power resource information and the network parameter information, the target service instance from a plurality of service instances corresponding to the one or more routing devices.

According to an eighth aspect, an embodiment of this application further provides a service processing apparatus. The apparatus includes: a packet parsing module, configured to receive a data packet sent by an ingress routing device, and parse the data packet to obtain identification information of a target service instance; and a service processing module, configured to determine, based on the identification information, an address indicated in the data packet, and send the data packet to the target service instance corresponding to the indicated address, so that the target service instance processes the data packet.

In a possible implementation, the identification information is obtained through parsing in one of the following manners: parsing a destination options header of the data packet to obtain option content carried by the destination options header, and determining the identification information based on the option content; parsing a segment routing header of the data packet to obtain a type-length-value of the segment routing header, and determining the identification information based on the type-length-value; or parsing a segment routing header of the data packet to obtain a segment list of the segment routing header, and determining the identification information based on a path indicated by the segment list.

According to a ninth aspect, an embodiment of this application further provides a service processing system. The system includes an ingress routing device and an egress routing device. The ingress routing device is configured to determine a target service instance corresponding to a target service requested by a client, and encapsulate identification information of the target service instance into a data packet from the client; and send the data packet to the egress routing device corresponding to the target service instance, so that the target service instance for the egress routing device processes the data packet. The egress routing device is configured to receive the data packet sent by the ingress routing device, and parse the data packet to obtain the identification information of the target service instance; and determine, based on the identification information, an address indicated in the data packet, and send the data packet to the target service instance corresponding to the indicated address, so that the target service instance processes the data packet.

According to a tenth aspect, an embodiment of this application further provides a service processing method, applied to a first routing device. The method includes: receiving a first data packet, where the first data packet carries identification information corresponding to a target service requested by a user; determining a target service instance corresponding to the target service; and sending a second data packet to a second routing device corresponding to the target service instance, where the second data packet is determined based on the first data packet, and the second data packet carries identification information corresponding to the target service instance.

In a possible implementation, before the determining the target service instance corresponding to the target service, the method further includes: receiving computing power and routing information sent by the second routing device, where the computing power and routing information is used to indicate a correspondence between the target service and one or more service instances, and the one or more service instances include the target service instance.

In a possible implementation, the first routing device is applied to compute first networking, the compute first networking includes one or more second routing devices, the one or more second routing devices are connected to a plurality of servers, and the plurality of servers are configured to provide the target service; and the determining the target service instance corresponding to the target service includes: determining computing power resource information of the plurality of servers and network parameter information of the one or more second routing devices; and determining, based on the computing power resource information and the network parameter information, the target service instance corresponding to the target service from a plurality of service instances corresponding to the plurality of servers.

In a possible implementation, after the determining the target service instance corresponding to the target service, the method further includes: replacing the identification information corresponding to the target service in the first data packet with the identification information corresponding to the target service instance.

In a possible implementation, after the determining the target service instance corresponding to the target service, the method further includes: adding, to an Internet Protocol version 6 IPv6 extension header of the first data packet, the identification information corresponding to the target service instance.

In a possible implementation, the IPv6 extension header of the data packet includes a destination options header, and the destination options header includes option content carrying the identification information.

In a possible implementation, the IPv6 extension header of the data packet includes a segment routing header, the segment routing header includes a type-length-value TLV, and the TLV includes the identification information corresponding to the target service instance.

In a possible implementation, the IPv6 extension header of the data packet includes a segment routing header, the segment routing header includes a segment list, and the identification information corresponding to the target service instance is located at an end of a path indicated by the segment list.

According to an eleventh aspect, an embodiment of this application further provides a service processing method, applied to a second routing device. The method includes: receiving a second data packet sent by a first routing device, where the second data packet is determined by the first routing device based on a first data packet received by the first routing device, and the second data packet carries identification information corresponding to a target service instance; and sending, based on the identification information, a third data packet to a server corresponding to the target service instance, where the third data packet is determined based on the second data packet.

In a possible implementation, before the sending the third data packet to the server corresponding to the target service instance, the method further includes at least one of the following: parsing a destination options header of the second data packet to obtain option content carried by the destination options header, and determining the identification information based on the option content; parsing a segment routing header of the second data packet to obtain a type-length-value of the segment routing header, and determining the identification information based on the type-length-value; or parsing a segment routing header of the second data packet to obtain a segment list of the segment routing header, and determining the identification information based on a path indicated by the segment list.

In a possible implementation, before the receiving the second data packet sent by the first routing device, the method further includes: sending computing power and routing information to the first routing device, where the computing power and routing information is used to indicate a correspondence between a target service of the second data packet and one or more service instances, and the one or more service instances include the target service instance.

In a possible implementation, in a case that the target service corresponds to a plurality of service instances, the sending, based on the identification information, the third data packet to the server corresponding to the target service instance includes: determining, based on the identification information corresponding to the target service instance, the server corresponding to the target service instance from a plurality of servers corresponding to the plurality of service instances; and sending the third data packet to the server corresponding to the target service instance.

In a possible implementation, the second data packet includes tunnel information, and before the sending, based on the identification information, the third data packet to the server corresponding to the target service instance, the method further includes: decapsulating the tunnel information in the second data packet; and using the decapsulated packet as the third data packet.

According to a twelfth aspect, an embodiment of this application further provides a service processing system, including a first routing device and a second routing device. The first routing device is configured to receive a first data packet, where the first data packet carries identification information corresponding to a target service requested by a user; determine a target service instance corresponding to the target service; and send a second data packet to a second routing device corresponding to the target service instance, where the second data packet is determined based on the first data packet, and the second data packet carries identification information corresponding to the target service instance. The second routing device is configured to receive the second data packet sent by the first routing device; and send, based on the identification information corresponding to the target service instance, a third data packet to a server corresponding to the target service instance, where the third data packet is determined based on the second data packet.

According to a thirteenth aspect, an embodiment of this application further provides a computer-readable storage medium. The computer-readable storage medium stores a computer program. When the computer program is executed by a processor, the method according to the first aspect and any design of the first aspect is implemented, or the method according to the second aspect and any design of the second aspect is implemented, or the method according to the fifth aspect and any design of the fifth aspect is implemented, or the method according to the sixth aspect and any design of the sixth aspect is implemented, or the method according to the tenth aspect and any design of the tenth aspect is implemented, or the method according to the eleventh aspect and any design of the eleventh aspect is implemented.

According to a fourteenth aspect, an embodiment of this application further provides an electronic device, including a memory and a processor. The memory stores a computer program capable of running on the processor. When the computer program is executed by the processor, the processor is enabled to implement the method according to the first aspect and any design of the first aspect, or implement the method according to the second aspect and any design of the second aspect, or implement the method according to the fifth aspect and any design of the fifth aspect, or implement the method according to the sixth aspect and any design of the sixth aspect, or implement the method according to the tenth aspect and any design of the tenth aspect, or implement the method according to the eleventh aspect and any design of the eleventh aspect.

According to a fifteenth aspect, an embodiment of this application further provides a service processing system, including a first router and a second router. The first router is configured to receive a first data packet, where the first data packet carries a service identifier SID; determine, based on the service identifier SID and computing power and routing information, a target binding identifier BID corresponding to the SID, where a mobile edge computing MEC site corresponding to the target BID is a target MEC site; and send a second data packet to a second router corresponding to the target MEC site, where the second data packet is determined based on the first data packet, and the second data packet carries the target BID. The second router is configured to receive the second data packet sent by the first router; and send a third data packet to the target MEC site corresponding to the target BID, where the third data packet is determined based on the second data packet.

### BRIEF DESCRIPTION OF DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a schematic diagram of compute first networking according to an embodiment of this application.

FIG. 2 is a schematic flowchart of conventional service processing in compute first networking according to an embodiment of this application.

FIG. 3 is a schematic flowchart of a service processing method according to an embodiment of this application.

FIG. 4 is a network architecture diagram of a service processing system according to an embodiment of this application.

FIG. 5 is a schematic flowchart of another service processing method according to an embodiment of this application.

FIG. 6 is a schematic diagram of a structure of a service processing apparatus according to an embodiment of this application.

FIG. 7 is a schematic flowchart of still another service processing method according to an embodiment of this application.

FIG. 8 is a schematic diagram in which an ingress routing device selects a target service instance according to an embodiment of this application.

FIG. 9 is a schematic diagram of a destination options header according to an embodiment of this application.

FIG. 10 is a schematic diagram of a destination options header to which identification information is added according to an embodiment of this application.

FIG. 11 is a schematic diagram of a segment routing header to which identification information is added according to an embodiment of this application.

FIG. 12 is a schematic flowchart of yet another service processing method according to an embodiment of this application.

FIG. 13 is a schematic diagram of a structure of another service processing apparatus according to an embodiment of this application.

FIG. 14 is a schematic diagram of a structure of still another service processing apparatus according to an embodiment of this application.

FIG. 15 is a schematic diagram of a service processing system according to an embodiment of this application.

FIG. 16 is a schematic flowchart of yet another service processing method according to an embodiment of this application.

FIG. 17 is a schematic flowchart of yet another service processing method according to an embodiment of this application.

FIG. 18 is a schematic diagram of a structure of an electronic device according to an embodiment of this application.

FIG. 19 is a schematic diagram of a service processing method in a service processing system according to an embodiment of this application.

### DESCRIPTION OF EMBODIMENTS

To make the objectives, technical solutions, and advantages of this application clearer, the following clearly and thoroughly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on embodiments of this application without creative efforts shall fall within the protection scope of this application. In absence of conflicts, the embodiments of this application and features in the embodiments may be combined arbitrarily. Moreover, although a logical order is shown in the flowchart, in some cases, the steps shown or described may be performed in an order different from this order.

In the specification, claims, and accompanying drawings of this application, the terms “first” and “second” are used to distinguish between different objects, and not intended to describe a specific order. In addition, the term “include” and any other variant thereof are intended to cover non-exclusive protection. For example, a process, method, system, product, or device that includes a list of steps or units is not limited to the listed steps or units, but optionally includes steps or units not listed, or optionally includes other steps or units inherent to the process, method, system, product, or device. The term “a plurality of” in this application may mean at least two, for example, two, three, or more. However, the embodiments of this application are not limited thereto.

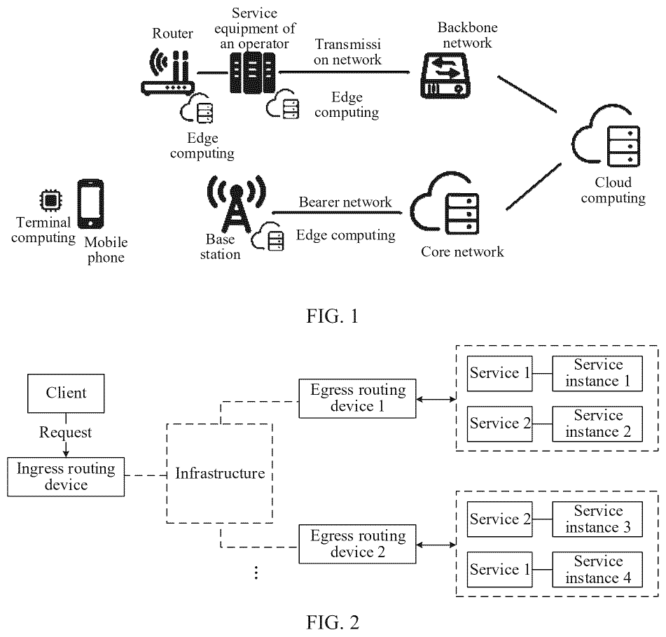

Compute first networking is a network architecture that deeply integrates computing power resources with a network, enabling interconnection of widely distributed computing power resources by using the network. FIG. 1 is a schematic diagram of compute first networking according to an embodiment of this application. As shown in FIG. 1, the compute first networking includes computing power resources on three levels: cloud computing nodes, edge computing nodes, and terminal computing nodes. The terminal computing nodes include terminal devices such as mobile phones, computers, and notebooks. The edge computing nodes include computing nodes (such as base stations) in a radio access network, computing nodes (such as routing devices and servers of operators) in a passive optical network (Passive Optical Network, PON), and the like. In practical application, the architecture of the compute first networking architecture may include more levels of computing power resources or fewer levels of computing power resources, and computing nodes at various levels may be implemented in other manners. In the compute first networking, a service requested by a user may be scheduled to an optimal computing node for service processing, to improve user experience and improve utilization of computing and network resources.

The compute first networking includes an ingress routing device and an egress routing device. The ingress routing device may be an ingress router (Ingress Router, IR). The egress routing device may be an egress router (Egress Router, ER). The ingress router IR is an ingress node of the compute first networking, and is connected to the user that requests the service. The egress router ER is an egress node of the compute first networking, and is connected to a computing node that provides the service for the user, and this computing node is also referred to as a server. In a conventional routing mode, the ingress router and the egress router usually make routing decisions respectively based on identification information corresponding to the service (for example, a service identifier SID). In other words, routing information and computing power information of the server (for example, a MEC site) corresponding to the SID are transmitted between routers (for example, the ingress router and the egress router) in the compute first networking, so that a computing node with optimal comprehensive computing power and network performance, such as an optimal MEC site, can be determined. During packet routing and forwarding, the user sends a data packet to the ingress router IR, where the data packet carries the SID. The SID may be used to indicate a service type requested by the user. One SID corresponds to one service type. The service type may be voice, video, or the like. The ingress router IR looks up a computing power and routing table based on the SID in the data packet, determines that an optimal MEC site is a MEC site 1, and transmits the data packet to an egress router ER corresponding to the MEC site 1. After receiving the data packet, the egress router ER may redetermine, by looking up a computing power and routing table based on the SID in the data packet, that an optimal MEC site is a MEC site 2, and then send the data packet to the MEC site 2. It should be noted that there may be one or more servers, such as MEC sites, configured to provide a service for the user. One MEC site corresponds to one service instance that can provide the service for the user, and the service instance corresponds to a piece of identification information, such as a binding identifier (Binding ID, BID), where the BID may be an IP address or another identifier that can be used to indicate the MEC site. Therefore, one SID can correspond to one or more BIDs. The service instance may be a server resource for providing a specific service for the user. The service instance may be set on a MEC site or another server device. However, because the computing power and routing table is constantly updated and changing, a time point at which the IR looks up the computing power and routing table is different from a time point at which the ER looks up the computing power and routing table, resulting in that the MEC site 1 determined by the IR through table lookup and the MEC site 2 determined by the ER through table lookup may be two different sites. Inconsistency of optimal MEC sites may lead to a routing loop problem, causing a service processing system to become unstable and affecting service experience.

FIG. 2 is a schematic flowchart of conventional service processing in compute first networking according to an embodiment of this application. As shown in FIG. 2, after receiving a service processing request sent by a user, an ingress routing device obtains a target service requested by the user (for example, logging in to an application, downloading a video, or initiating a voice request), where the service processing request carries identification information (for example, a service identifier SID 1) indicating the target service. Based on computing power resources and network resources of various service instances in the compute first networking, the ingress routing device decides an optimal target service instance, that is, a service instance 1 shown in FIG. 2, from numerous service instances that can provide the target service. Identification information corresponding to the service instance 1 may be a binding identifier BID 1. The service instance may be a server resource for providing a specific service for the user. The service instance may be set on a MEC site or another server device. Because a server device corresponding to the service instance 1 is connected to an egress routing device 1, a data packet used for service processing is sent to the egress routing device 1.

In a conventional technology, after receiving the packet, the egress routing device 1 needs to make a decision again based on current computing power resources and network resources of various service instance in the compute first networking. If computing power resources or network resources of a server change at this time, computing power and routing resources stored by the ingress routing device and the egress routing device may be out of synchronization. Further, the optimal computing power node determined by the egress routing device 1 at this time may be a service instance 4 corresponding to an egress routing device 2. Consequently, decision results of the ingress routing device and the egress routing device are inconsistent, a loop problem is caused, and finally, the service cannot be processed.

In addition, a service in the compute first networking has a “sticky” requirement for a server. In other words, after a first packet of a service in the computing first networking is processed by a server, subsequent packets of the computing power service also need to be processed by the server; otherwise, continuity of the service is destroyed. Because the network resources and computing power resources in the compute first networking change in real time, the optimal computing nodes also change, and data of a service flow is distributed to different servers for processing, resulting in service interruption. Based on this, the compute first networking in the related technology requires that the routing device should maintain a session table for recording a mapping relationship between a service flow and a computing node. A unique service instance indicating the service flow is set on a computing node, to ensure that all packets corresponding to the same service flow are forwarded to the same service instance for processing. Because the ingress routing device is connected to a local user, and a quantity of services of the local user is relatively limited, a quantity of session entries maintained by the ingress routing device is controllable. However, the egress routing device is connected to the server, and all data destined for the server may be recorded in session entries, resulting in a large quantity of session entries. Therefore, a large quantity of forwarding resources on the egress routing device need to be consumed to maintain the session entries.

To resolve the foregoing disadvantages, this application provides a service processing method and system, a storage medium, and an electronic device to improve stability of the service processing system.

The service processing method provided by this application may be performed by a first routing device (for example, an ingress routing device) and a second routing device (for example, an egress routing device). After obtaining a first data packet, the first routing device may determine, based on identification information (for example, a service identifier SID) corresponding to a service requested by a user in the first data packet and computing power and routing information, identification information (for example, a target BID) of a target service instance corresponding to the SID in the first data packet. A server device corresponding to the target BID is a target server device corresponding to the target service instance, for example, a target MEC site. It should be noted that the service instance may be a server resource for providing a specific service for the user. The service instance may be set on a MEC site or another server device. The first routing device sends a second data packet to the second routing device corresponding to the target MEC site, where the second data packet carries the target BID. The second routing device directly sends a third data packet to the target MEC site based on the target BID in the second data packet.

In a possible implementation, the first data packet, the second data packet, and the third data packet include same payload. In addition, the first routing device and the second routing device may be included in a computer system for performing the method shown in this application, or may be processing apparatuses in a computer system for performing the method shown in this application, such as processors or processing modules. This is not specifically limited in this application.

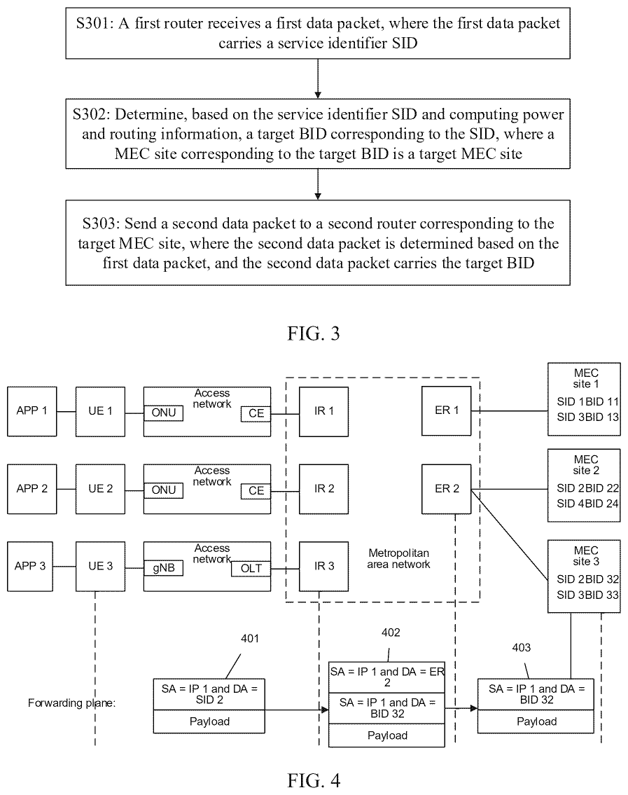

FIG. 3 is a schematic flowchart of a service processing method according to an embodiment of this application. The procedure may include the following steps.

S301: A first router receives a first data packet, where the first data packet carries a service identifier SID.

FIG. 4 is a network architecture diagram of a service processing system according to an embodiment of this application. The first router may be an IR 1 or an IR 2 in FIG. 4, that is, an ingress routing device in compute first networking. Using FIG. 4 as an example, the IR 1 or the IR 2 may obtain a first data packet from a customer edge (Customer Edge, CE) device, where the first data packet carries service information requested by a user, that is, a service identifier SID. Alternatively, the first router may be an IR 3 in FIG. 4. Using FIG. 4 as an example, the IR 3 may obtain a first data packet through an optical line terminal (Optical Line Terminal, OLT).

In a possible implementation, the first data packet may include data and tunnel information. For example, as shown in a packet 401 in FIG. 4, the tunnel information includes a source address (Source Address, SA) and a destination address (Destination Address, DA). The SA may be represented by an Internet Protocol (Internet Protocol, IP) address, and the DA may be represented by a SID. In addition, the data may include payload (Payload).

S302: The first router determines, based on the SID carried in the first data packet and computing power and routing information, a target BID corresponding to the SID in the first data packet, where a MEC site corresponding to the target BID is a target MEC site.

In a possible implementation, one service type corresponds to one SID, one SID corresponds to one or more BIDs, and one BID corresponds to one MEC site. In a possible implementation, the SID carried in the first data packet may be a SID 1 in FIG. 4, the SID 1 may be used to uniquely identify a service 1, a BID corresponding to the SID 1 may be a BID 11, a MEC site corresponding to the BID 11 is a MEC site 1, and the MEC site 1 is the target MEC site.

In a possible implementation, the SID in the first data packet may alternatively be a SID 2 in FIG. 4, and BIDs corresponding to the SID 2 include a BID 22 and a BID 32, where a MEC site corresponding to the BID 22 is a MEC site 2 and a MEC site corresponding to the BID 32 is a MEC site 3. The first router may select a MEC site with optimal comprehensive computing power and network performance from the MEC site 2 and the MEC site 3 as the target MEC site based on the computing power and routing information. Then the first router may determine that a BID corresponding to the target MEC site is a target BID corresponding to the SID 2. The computing power and routing information may include computing power information and routing information. The computing power information refers to a computing capability of the MEC site, such as computing power parameters of a central processing unit (Central Processing Unit, CPU) and a graphics processing unit (Graphics Processing Unit, GPU). The routing information refers to a network delay, bandwidth, and other information. It may be determined, based on computing power and network routing information of the MEC site, that the MEC site with optimal comprehensive performance is the target MEC site.

Table 1 is computing power and routing information according to an embodiment of the present invention, including a service identifier SID 2, two BIDs corresponding to the SID 2, routing information corresponding to each BID, computing power information, and a corresponding next hop. An optimal next hop of the SID 2 may be determined based on a formula 1:

FM=CM*CW+NM*NW (Formula 1)

In the formula, FM is a comprehensive solution to computing power and routing, CM is computing power information, CW is computing power weight, NM is routing information, and NW is routing weight.

When FW is the optimal solution, it may be assumed that an optimal solution of FW is a smallest value among a plurality of solutions, and the corresponding next hop is the target MEC site.

It should be noted that a computing node that provides a service for the user may be a MEC site or another type of server.

TABLE 1

| Service | Binding | Routing | Computing power | |
|---|---|---|---|---|
| type | identifier | information NM | information CM | Next hop |
| SID 2 | BID 22 | N1 | C1 | MEC site 2 |
| | BID 32 | N2 | C2 | MEC site 3 |

In a possible implementation, before determining, based on the service identifier SID carried in the first data packet and the computing power and routing information, the target BID corresponding to the SID, the first router may further receive the computing power and routing information sent by a second router. Correspondingly, the second router sends the computing power and routing information to the first router. Specifically, the second router collects the computing power and routing information and sends the computing power and routing information to the first router. The computing power and routing information is used to indicate a correspondence between the SID and one or more BIDs, and the one or more BIDs include the target BID.

In a possible implementation, the first router determines, based on the SID carried in the first data packet and the computing power and routing information, the BID corresponding to the SID, and the first router determines the corresponding target MEC site based on the BID corresponding to the SID.

Specifically, the first router receives the computing power and routing information sent by the second router. As shown in Table 1, the computing power and routing information is configured to indicate a correspondence between the SID 2 and two BIDs. Therefore, the first router can determine that the BIDs corresponding to the SID 2 are the BID 22 and the BID 32. In addition, one BID corresponds to one MEC site, that is, the SID 2 corresponds to two MEC sites: the MEC site 2 and the MEC site 3. Therefore, the first router can further determine, from the MEC site 2 and the MEC site 3 based on the computing power and routing information, a MEC site corresponding to an optimal comprehensive solution to computing power and routing, and this MEC site is the target MEC site. The BID corresponding to the target MEC site is the target BID.

In a possible implementation, the second router may collect and store the correspondence between the SID and the one or more BIDs. Therefore, the second router can send the correspondence between the SID and the one or more BIDs to the first router. As shown in FIG. 4, the second router may be an ER 2, and the SID 2 corresponds to the BID 22 and BID 32. The ER 2 may send the correspondence between the SID 2 and the BID 22 and BID 32 to the first router. The ER 2 may also collect routing information and computing power information corresponding to the BID 22 and BID 32, and send the routing information and the computing power information to the first router.

In a possible implementation, the first router determines the target BID based on the SID in the first data packet and the computing power and routing information, and replaces the SID with the target BID, so that the first router changes a propagation mode of the first data packet from anycast to unicast. As shown in FIG. 4, MEC sites supporting a service with a SID 3 include the MEC site 1 and the MEC site 3. A second router corresponding to the MEC site 1 is an ER 1, and a second router corresponding to the MEC site 3 is the ER 2. In other words, the first router may send data to the ER 1 or send data to the ER 2. However, after determining, based on the SID 3 and the computing power and routing information, that the target MEC site is the MEC site 3, the first router can only send data to the ER 2. Therefore, the first router changes the propagation mode of the first data packet from anycast to unicast, thereby making the overall solution clear and simple and simplifying operation and maintenance.

By using this method, the first router can determine the target BID based on the SID in the first data packet and the computing power and routing information, where each BID corresponds to only one MEC site. In this way, a possible routing loop problem arising from selecting different MEC sites at different time points due to different computing power and routing information is avoided, and the service processing system becomes more stable.

S303: The first router sends a second data packet to a second router corresponding to the target MEC site.

In a possible implementation, the second router may be the ER 1 or the ER 2 in FIG. 4, that is, an egress routing device in the compute first networking.

In this embodiment of this application, the ingress routing device makes a routing decision to determine the target BID, and the egress routing device may directly instruct, based on the target BID information carried in the packet, the target MEC site to process the data packet. Therefore, a possible loop problem arising from decisions simultaneously made by the ingress routing device and the egress routing device can be solved. Moreover, because the egress routing device does not need to make a routing decision, the egress routing device does not need to maintain a session entry that carries a mapping between a service flow and a server. Therefore, forwarding resource requirements of the egress routing device can be effectively reduced.

In a possible implementation, the second data packet may be determined based on the first data packet. For example, the second data packet and the first data packet may carry the same data or payload. In addition, the second data packet further carries the target BID.

In a possible implementation, the first router may replace the SID in the first data packet with the target BID corresponding to the target MEC site, to generate the second data packet.

In a possible implementation, the second data packet carries the same data or payload as the first data packet, and the target BID may also be carried in the payload. As shown in FIG. 4, the first data packet is a packet 401 and the second data packet is a packet 402. Payload in the packet 402 is the same as payload in the packet 401. The first router may encapsulate fields (SA=IP 1 and DA=BID 32) in an outer layer of the payload, indicating that the payload needs to be forwarded to the target MEC site corresponding to the BID 32. The first router may further reencapsulate the payload of the packet 402 and the fields (SA=IP 1 and DA=BID 32) encapsulated in the outer layer of the payload, that is, further add tunnel information (SA=IP 1 and DA=ER 2).

In a possible implementation, the second data packet may further directly carry the target BID in the tunnel information. For example, when the first router sends the second data packet to the second router, the first router encapsulates the first data packet or the payload of the first data packet, and the tunnel information of the second data packet obtained after encapsulation carries the target BID. For example, the tunnel information carries fields (SA=IP 1, and DA=ER 2 and BID 32), indicating that the payload needs to be forwarded to the target MEC site corresponding to the BID 32.

FIG. 5 is a schematic flowchart of another service processing method according to an embodiment of this application. In FIG. 5, the following steps are included.

S501: A second router receives a second data packet sent by a first router, where the second data packet is determined by the first router based on a received first data packet, the second data packet carries a target BID, and the target BID is determined by the first router based on a SID carried in the first data packet and computing power and routing information.

S502: The second router sends a third data packet to a target MEC site, where the third data packet is determined based on the second data packet.

In a possible implementation, before the receiving the second data packet sent by the first router, the method further includes: the second router sends the computing power and routing information to the first router, where the computing power and routing information is used to indicate a correspondence between the SID and one or more BIDs, and the one or more BIDs include the target BID.

In a possible implementation, in a case that the SID corresponds to a plurality of BIDs, that the second router sends the third data packet to the target MEC site corresponding to the target BID includes: the second router determines, based on the target BID carried in the second data packet, the target MEC site corresponding to the target BID from a plurality of MEC sites corresponding to the plurality of BIDs; and the second router sends the third data packet to the target MEC site, where the third data packet is determined based on the second data packet.

In a possible implementation, the second data packet includes tunnel information, and before the sending the third data packet to the target MEC site corresponding to the target BID, the method further includes: decapsulating the tunnel information in the second data packet; and using the decapsulated packet as the third data packet. As shown in FIG. 4, the second router may be an ER 2. When the second data packet is a packet 402 shown in FIG. 4, the second router may decapsulate tunnel information (SA=IP 1 and DA=ER 2) in an outer layer of the packet 402, and then use a remaining part as the third data packet, that is, use a packet 403 as the third data packet. The ER 2 may determine, based on a BID 32 carried in the packet 402, that a target MEC site corresponding to the BID 32 is a MEC site 3, and send the packet 403 to the MEC site 3 corresponding to the BID 32.

By using this method, the second router determines the target MEC site based on the target BID in the second data packet. Because one BID corresponds to one MEC site, the second router can be connected to the plurality of MEC sites. Therefore, in a case that a quantity of MEC sites is fixed, a quantity of second routers is reduced, and costs are reduced, and this better aligns with a practical application scenario of compute first networking.

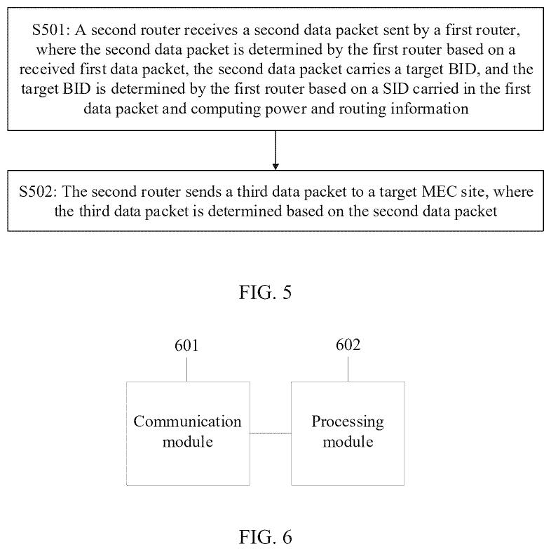

Based on the foregoing content and the same concept, this application provides a service processing apparatus. As shown in FIG. 6, the apparatus includes a communication module 601 and a processing module 602.

When the service processing apparatus is disposed in a first router, the communication module 601 is configured to receive a first data packet, where the first data packet carries a service identifier SID; the processing module 602 is configured to determine, based on the service identifier SID carried in the first data packet and computing power and routing information, a target binding identifier BID corresponding to the SID, where a MEC site corresponding to the target BID is a target MEC site; and the communication module 601 is further configured to send a second data packet to a second router corresponding to the target MEC site, where the second data packet is determined based on the first data packet, and the second data packet carries the target BID.

It should be noted that a computing node configured to provide a service for a user may be a MEC site or another type of server.

In a possible implementation, in a case that the SID corresponds to a plurality of BIDs, the processing module 602 is further configured to determine, based on the service identifier SID and the computing power and routing information, the target MEC site from a plurality of MEC sites corresponding to the plurality of BIDs, where the computing power and routing information includes computing power information and routing information; and determine that the BID corresponding to the target MEC site is the target BID corresponding to the SID.

In a possible implementation, before determining, based on the service identifier SID carried in the first data packet and the computing power and routing information, the target binding identifier BID corresponding to the SID, the communication module 601 is further configured to receive the computing power and routing information sent by the second router, where the computing power and routing information is used to indicate a correspondence between the SID and one or more BIDs, and the one or more BIDs include the target BID.

In a possible implementation, after determining, based on the service identifier SID and the computing power and routing information, the target binding identifier BID corresponding to the SID, the processing module 602 is further configured to replace the SID in the first data packet with the target BID.

When the service processing apparatus is disposed in the second router, the communication module 601 is configured to receive a second data packet sent by a first router, where the second data packet is determined by the first router based on a received first data packet, the second data packet carries a target BID, and the target BID is determined based on a SID carried in the first data packet and computing power and routing information; and the communication module 601 is further configured to send a third data packet to a target MEC site corresponding to the target BID, where the third data packet is determined based on the second data packet.

In a possible implementation, before receiving the second data packet sent by the first router, the communication module 601 is further configured to send the computing power and routing information to the first router, where the computing power and routing information includes a correspondence between the SID and one or more BIDs, and the one or more BIDs include the target BID.

In a possible implementation, the service processing apparatus further includes the processing module 602. In a case that the SID corresponds to a plurality of BIDs, the processing module 602 is configured to determine, based on the target BID, the target MEC site corresponding to the target BID from a plurality of MEC sites; and the communication module 601 is configured to send the third data packet to the target MEC site.

In a possible implementation, the second data packet includes tunnel information, and the processing module 602 is further configured to decapsulate the tunnel information in the second data packet; and use the decapsulated packet as the third data packet.

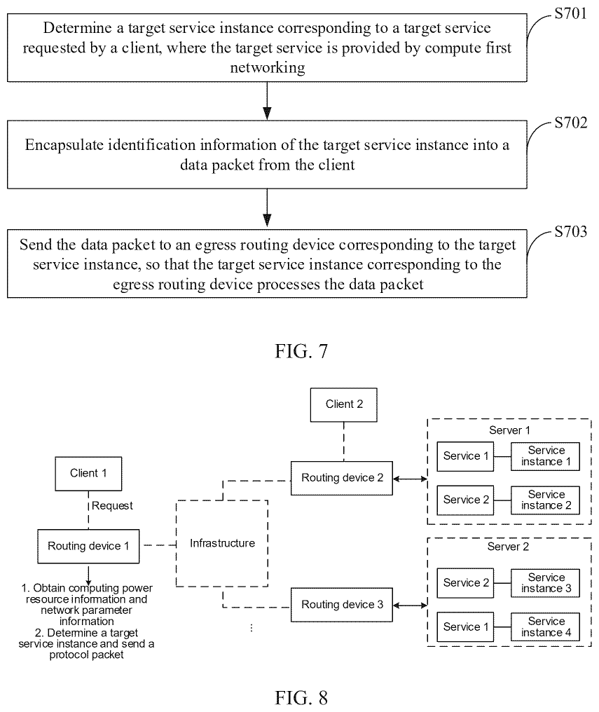

An embodiment of this application further provides a service processing method in compute first networking. FIG. 7 is a schematic flowchart of still another service processing method according to an embodiment of this application. As shown in FIG. 7, the method includes the following steps.

Step S701: Determine a target service instance corresponding to a target service requested by a client, where the target service is provided by the compute first networking.

With reference to FIG. 8, an ingress routing device is connected to a client. When the client raises a service requirement such as login to an application or video downloading, the client may send a service processing request to the ingress routing device. The request carries a target service required by the customer. Using login to the application as an example, the target service is a service provided by the application.

In a possible implementation, the compute first networking includes one or more routing devices, each routing device is connected to one or more servers, and the one or more servers are configured to provide the target service. The ingress routing device obtains computing power resource information of servers corresponding to the one or more routing devices in the compute first networking and network parameter information of the one or more routing devices, where the network parameter information includes at least a network delay and bandwidth of the routing device; and selects, based on the computing power resource information and the network parameter information, a target service instance corresponding to the target service from a plurality of service instances corresponding to the one or more routing devices.

FIG. 8 is a schematic diagram in which an ingress routing device selects a target service instance according to an embodiment of this application. As shown in FIG. 8, the compute first networking includes a plurality of routing devices, where some routing devices (such as a routing device 1 shown in FIG. 8) are connected only to clients, some routing devices (such as a routing device 2 shown in FIG. 8) are connected to both clients and servers, and some routing devices (such as a routing device 3 shown in FIG. 8) are connected only to servers. A purpose of step S701 is to select, based on the target service required by the customer and with reference to computing power resource information of a server corresponding to each routing device and network parameter information of each routing device, a service instance from a plurality of service instances corresponding to different routing devices, where the service instance is used to process a data packet, to respond to the service processing request of the client. The selected service instance may be a service instance with optimal comprehensive computing power resources and network conditions among the plurality of service instances.

Step S701 is described with reference to FIG. 8. A client 1 sends a service processing request to the routing device 1, where the routing device 1 is an ingress routing device corresponding to the request. The routing device 1 obtains the computing power resource information of the server corresponding to each routing device in the compute first networking and the network parameter information of each routing device. In other words, computing power resource information of servers (that is, a server 1 and a server 2) corresponding to the routing device 2 and the routing device 3, and network parameter information of the routing device 2 and the routing device 3 are obtained. The computing power resource information may include computing power resources such as remaining computing power of the server connected to the routing device and processor usage. The network parameter information may include network parameters such as the network bandwidth and delay of the routing device.

The routing device 1 selects, based on the obtained computing power resource information and network parameter information, the target service instance from the service instances corresponding to the target service. For example, assuming that the target service required by the customer is a service 2, the routing device 1 may select, from various routing devices in advance, the routing device 2 and the routing device 3 that are connected to the servers corresponding to the service 2. Then the routing device 1 determines, with reference to the computing power resource information and network parameter information, that a service instance 4 connected to the routing device 3 is an optimal service instance. The routing device 3 which the service instance 4 is corresponding to is an egress router corresponding to the request, and the service instance 4 is the target service instance for the request.

Step S702: Encapsulate identification information of the target service instance into a data packet from the client.

The Internet Protocol version 6 (IPv6) specifies various extension headers (Extension headers), such as a hop-by-hop options header, a destination options header, and a segment routing header. Presence of an IPv6 extension header may provide some additional information for the packet. For example, the identification information of the target service instance, that is, a binding identifier BID, is added. In a possible implementation, before the binding identifier BID of the target service instance is added to the data packet, it may be predetermined whether the data packet has an IPv6 extension header. If there is no IPv6 extension header, an IPv6 extension header may be added to the data packet, so that the IPv6 extension header can carry the binding identifier BID of the target service instance.

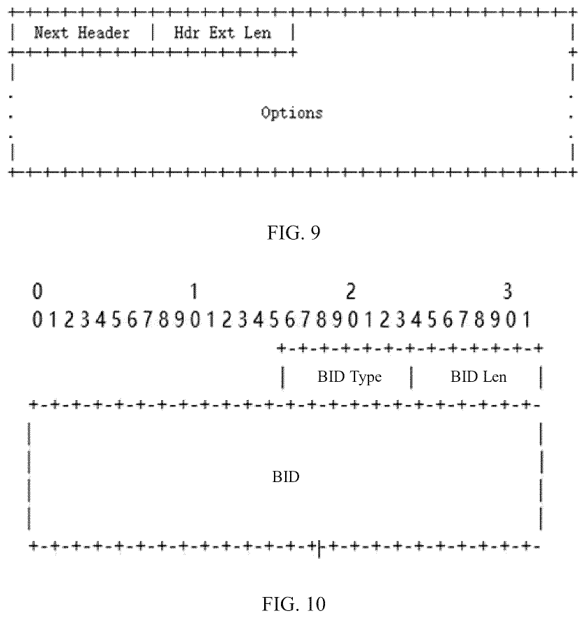

In a possible implementation, a destination options header (Destination Options Header, DOH) may be added to the data packet, and the binding identifier BID may be used as custom option content of the destination options header. FIG. 9 is a schematic diagram of a destination options header according to an embodiment of this application. As shown in FIG. 9, the destination options header may carry a plurality of options (Options), and a format of the options (Options) is usually “type-length-value” (Type-Length-Value, TLV for short). FIG. 10 is a schematic diagram of a destination options header to which identification information is added according to an embodiment of this application. Options in the TLV format as shown in FIG. 10 may be constructed in the destination options header to define a type (BID Type) and a length (BID Len) of the binding identification information of the target service instance, and add the binding identifier BID of the target service instance as custom option content (value). It should be noted that the BID may be not only carried by using the custom option content, but also carried by using other option content in the destination options header.

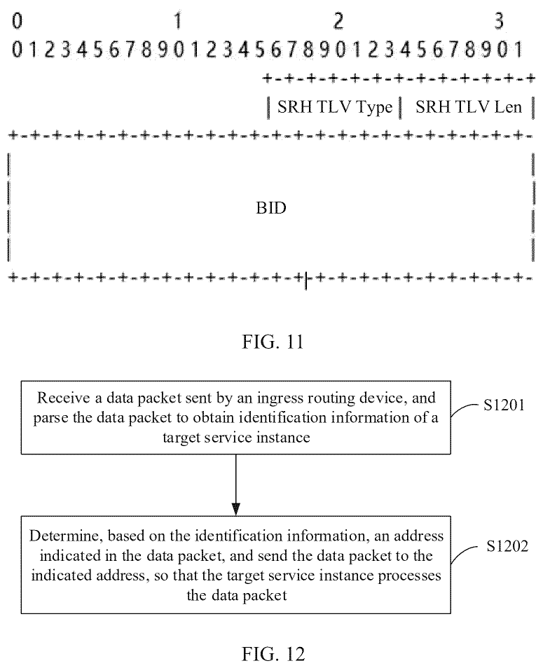

In a possible implementation, a segment routing header (Segment Routing Header, SRH) may also be added to the data packet, and the binding identifier BID is used as a first type-length-value of the segment routing header. Specifically, the segment routing header includes an SRH TLV with functions similar to those of the destination options header. FIG. 11 is a schematic diagram of a segment routing header to which identification information is added according to an embodiment of this application. As shown in FIG. 11, a type (SRH TLV Type) and a length (SRH TLV Len) of the binding identification information of the target service instance are defined. For example, the type (SRH TLV Type) is defined as a first value (BID Type), and the BID is added as a value (content) of the SRH TLV. In addition, considering that the segment routing header also carries a segment list (SRH segment list) for recording a path, during implementation, the identification information may be added to an end of the path indicated by the segment list, so that the data packet carries the binding identifier BID.

Correspondingly, if the data packet originally carries the segment routing header or the destination options header, there is no need to add a new extension header, and only the binding identifier BID needs to be added to the header in the foregoing manner of addition corresponding to the segment routing header or the destination options header.

It should be noted that although a plurality of manners of adding identification information are provided in the foregoing examples, in practical application, a rule for adding identification information needs to be specified in advance. After an egress routing device receives a data packet, a binding identifier BID can be obtained by parsing the data packet by using a corresponding parsing rule. For example, the data packet originally carries a segment routing header, but does not carry a destination options header. If a preset adding rule requires that identification information should be added by using the destination options header, even if the data packet carries the segment routing header, it is still necessary to add the destination options header to the data packet to carry a binding identifier BID of a target service instance.

For example, the routing devices in the compute first networking may prescribe or configure a type (Type) value of a TLV in the segment routing header as a first value (BID Type), which is used to indicate that the TLV includes the identification information of the target service instance, that is, the TLV is the foregoing SRH TLV.

Alternatively, for example, the routing devices (ingress routing device and egress routing device) in the compute first networking may prescribe or configure a type (Type) value of options (Options) in the destination options header as a second value (BID Type), which is used to indicate that the options include the binding identifier BID of the target service instance.

Step S703: Send the data packet to an egress routing device corresponding to the target service instance, so that the target service instance corresponding to the egress routing device processes the data packet.

After the identification information of the target service instance, that is, the binding identifier BID, is added to the data packet in step S702, the data packet needs to be sent to the egress routing device corresponding to the target service instance, so that the egress routing device instructs, based on the binding identifier BID, the target service instance to perform service processing for the customer.

In the foregoing procedure, only the ingress routing device needs to make a decision. Based on the binding identifier BID carried in the packet, the egress routing device may directly instruct the target service instance to process the data packet in response to the service processing request of the client. In this way, a possible loop problem arising from decisions simultaneously made by the ingress routing device and the egress routing device is solved. Moreover, because the egress routing device does not need to make a decision, the egress routing device does not need to maintain a session entry that carries a mapping between a service flow and a server. Therefore, forwarding resource requirements of the egress routing device can be effectively reduced.

The following describes a processing procedure performed by an egress routing device. FIG. 12 is a schematic flowchart of yet another service processing method according to an embodiment of this application. As shown in FIG. 12, the method includes the following steps.

Step S1201: Receive a data packet sent by an ingress routing device, and parse the data packet to obtain identification information of a target service instance.

As described in step S702, the identification information of the target service instance may be added to a destination options header or a segment routing header in this embodiment of this application. Specifically, a rule for adding the identification information may be specified in advance. After the egress routing device receives the data packet, the egress routing device parses the data packet by using a corresponding parsing rule, to obtain the identification information.

In a possible implementation, if the identification information is added by using the destination options header, custom option content carried by the destination options header may be obtained by parsing the destination options header of the data packet. Then the identification information is determined based on the custom option content. It should be noted that the identification information may be not only carried by using the custom option content, but also carried by using other option content in the destination options header.

In a possible implementation, if the identification information is added by using a TLV field of the segment routing header, a type-length-value of the segment routing header may be obtained by parsing the segment routing header of the data packet. Then the identification information is determined based on the type-length-value.

In a possible implementation, if the identification information is added by using a segment list of the segment routing header, the segment list of the segment routing header may be obtained by parsing the segment routing header of the data packet. Then the identification information is determined based on a path indicated by the segment list.

Step S1202: Determine, based on the identification information, an address indicated in the data packet, and send the data packet to the target service instance corresponding to the indicated address, so that the target service instance processes the data packet.

It should be noted that the manner in which the first router replaces the SID in the packet with the BID and then forwards the packet carrying the BID information to the second router in the foregoing embodiment can also solve a possible loop problem arising from decisions simultaneously made by the ingress routing device and the egress routing device. A request packet sent by the first router to the second router is an outgoing packet.

However, to ensure that a source address and a destination address of a response packet (that is, a return packet) fed back by the second router to the first router can correspond to those of the outgoing packet, that is, to maintain a correspondence between the source address of the outgoing packet and the destination address of the return packet and a correspondence between the destination address of the outgoing packet and the source address of the return packet, the ingress routing device needs to replace a BID in the received return packet with a SID, and this conversion action increases complexity of the ingress routing device in processing the return packet.

In this embodiment of this application, after the identification information of the target service instance, that is, the binding identifier BID, is obtained, the identification information is used as the address indicated in the data packet, and the data packet is sent to the target service instance corresponding to the indicated address for service processing. Specifically, in this embodiment of this application, the destination address originally carried in the data packet is not directly replaced from the service identifier SID corresponding to the target service to the binding identifier BID corresponding to the target service instance; instead, the binding identifier BID of the target service instance is added to the extension header of the data packet. Therefore, the egress routing device receiving the data packet only needs to be set to forward the data packet to the target service instance indicated by the binding identifier BID, so that the target service instance can process the data packet in response to the service processing request of the client. Moreover, in this embodiment of this application, the ingress routing device does not need to convert the BID in the return packet into the SID either, so that complexity of the ingress routing device in processing the return packet is not additionally increased.

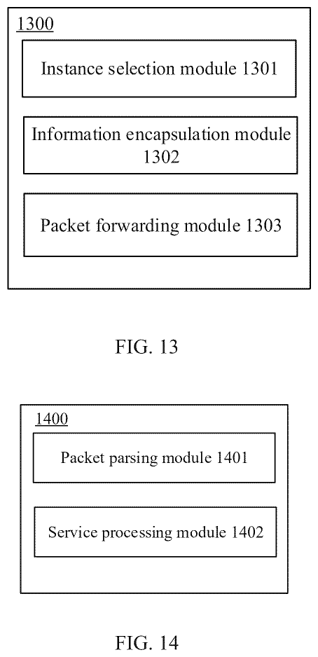

Based on the same inventive concept, an embodiment of this application further provides a service processing apparatus 1300 in compute first networking, and the service processing apparatus 1300 is disposed in an ingress routing device. FIG. 13 is a schematic diagram of a structure of another service processing apparatus 1300 according to an embodiment of this application. As shown in FIG. 13, the apparatus includes: an instance selection module 1301, configured to determine a target service instance corresponding to a target service requested by a client; an information encapsulation module 1302, configured to encapsulate identification information of the target service instance into a data packet from the client; and a packet forwarding module 1303, configured to send the data packet to an egress routing device corresponding to the target service instance, so that the target service instance corresponding to the egress routing device processes the data packet.

In some possible embodiments, the information encapsulation module 1302 is configured to add the identification information of the target service instance to an IPv6 extension header of the data packet.

In some possible embodiments, the IPv6 extension header of the data packet includes a destination options header, and the destination options header includes option content carrying the identification information.

In some possible embodiments, the IPv6 extension header of the data packet includes a segment routing header, the segment routing header includes a type-length-value TLV, and the TLV includes the identification information of the target service instance.

In some possible embodiments, the IPv6 extension header of the data packet includes a segment routing header, the segment routing header includes a segment list, and the identification information is located at an end of a path indicated by the segment list.

In some possible embodiments, the compute first networking includes one or more routing devices, each routing device is connected to one or more servers, and the one or more servers are configured to provide the target service. The instance selection module 1301 is configured to obtain computing power resource information of servers corresponding to the one or more routing devices in the compute first networking and network parameter information of the one or more routing devices, where the network parameter information includes at least a network delay and bandwidth of the routing device; and select, based on the computing power resource information and the network parameter information, the target service instance corresponding to the target service from a plurality of service instances corresponding to the one or more routing devices.

Based on the same inventive concept, an embodiment of this application further provides another service processing apparatus 1400 in compute first networking, and the service processing apparatus 1400 is disposed in an egress routing device. FIG. 14 is a schematic diagram of a structure of still another service processing apparatus 1400 according to an embodiment of this application. As shown in FIG. 14, the apparatus includes: a packet parsing module 1401, configured to receive a data packet sent by an ingress routing device, and parse the data packet to obtain identification information of a target service instance; and a service processing module 1402, configured to determine, based on the identification information, an address indicated in the data packet, and send the data packet to the target service instance corresponding to the indicated address, so that the target service instance processes the data packet.

In some possible embodiments, the identification information is obtained through parsing in one of the following manners: manner 1: parsing a destination options header of the data packet to obtain custom option content carried by the destination options header, and determining the identification information based on the custom option content; manner 2: parsing a segment routing header of the data packet to obtain a type-length-value TLV of the segment routing header, and determining the identification information based on the type-length-value TLV; and manner 3: parsing a segment routing header of the data packet to obtain a segment list of the segment routing header, and determining the identification information based on a path indicated by the segment list. It should be noted that the BID may be not only carried by using the custom option content, but also carried by using other option content in the destination options header.

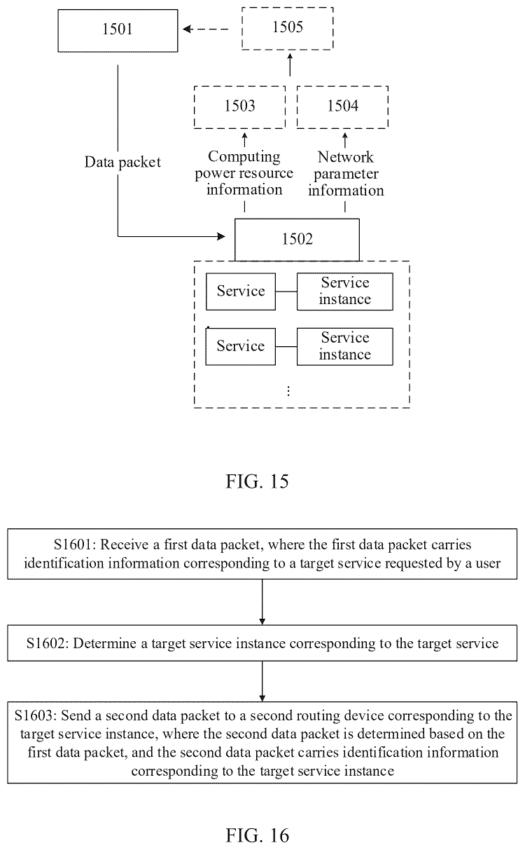

Based on the same inventive concept, an embodiment of this application further provides a service processing system in compute first networking. FIG. 15 is a schematic diagram of a service processing system according to an embodiment of this application. Specifically, as shown in FIG. 15, the system includes an ingress routing device 1501 and an egress routing device 1502.

The ingress routing device 1501 is configured to determine a target service instance corresponding to a target service requested by a client, and encapsulate identification information of the target service instance into a data packet from the client; and send the data packet to the egress routing device corresponding to the target service instance, so that the target service instance corresponding to the egress routing device processes the data packet.

The egress routing device 1502 is configured to receive the data packet sent by the ingress routing device, and parse the data packet to obtain the identification information of the target service instance; and determine, based on the identification information, an address indicated in the data packet, and send the data packet to the target service instance corresponding to the indicated address, so that the target service instance processes the data packet.

In some possible embodiments, the compute first networking includes a plurality of routing devices connected to servers. The service processing system further includes a computing power parameter collection unit 1503, a network parameter collection unit 1504, and a comprehensive decision-making unit 1505. The computing power parameter collection unit 1503 is configured to collect computing power resource information of each server connected to each routing device. The network parameter collection unit 1504 is configured to collect network parameter information of the routing device. The computing power parameter collection unit 1503 and the network parameter collection unit 1504 send the collected computing power resource information and network parameter information to the comprehensive decision-making unit 1505, so that the comprehensive decision-making unit 1505 selects an optimal service instance (that is, a target service instance) and network path for a service request based on the collected information. Therefore, the ingress routing device 1501 can forward the data packet based on the target service instance selected by the comprehensive decision-making unit 1505.

An embodiment of this application further provides a service processing method in compute first networking. The method is applied to a first routing device, and the first routing device may be an ingress routing device. FIG. 16 is a schematic flowchart of yet another service processing method according to an embodiment of this application. As shown in FIG. 16, the method includes the following steps.

S1601: Receive a first data packet, where the first data packet carries identification information corresponding to a target service requested by a user. The identification information corresponding to the target service may be a service identifier SID.

S1602: Determine a target service instance corresponding to the target service.

S1603: Send a second data packet to a second routing device corresponding to the target service instance, where the second data packet is determined based on the first data packet, and the second data packet carries identification information corresponding to the target service instance. The identification information corresponding to the target service instance may be a binding identifier BID.

In a possible implementation, before the determining the target service instance corresponding to the target service, the method further includes: receiving computing power and routing information sent by the second routing device, where the computing power and routing information is used to indicate a correspondence between the target service and one or more service instances, and the one or more service instances include the target service instance.

In a possible implementation, the first routing device is applied to compute first networking, the compute first networking includes one or more second routing devices, the one or more second routing devices are connected to a plurality of servers, and the plurality of servers are configured to provide the target service. The determining the target service instance corresponding to the target service includes: determining computing power resource information of the plurality of servers and network parameter information of the one or more second routing devices; and determining, based on the computing power resource information and the network parameter information, the target service instance corresponding to the target service from a plurality of service instances corresponding to the plurality of servers.

It should be noted that, that the one or more second routing devices are connected to the plurality of servers may include the following cases.

Case 1: The one or more second routing devices include one second routing device, and the one second routing device is connected to a plurality of servers at the same time.

Case 2: The one or more second routing devices include a plurality of second routing devices, and each second routing device is connected to only one server, so that the plurality of second routing devices can be connected to a plurality of servers.

Case 3: The one or more second routing devices include a plurality of second routing devices, where some second routing devices are connected to only one server, and other second routing devices are connected to a plurality of servers, so that the plurality of second routing devices can be connected to a plurality of servers.

In a possible implementation, after the determining the target service instance corresponding to the target service, the method further includes: replacing the identification information corresponding to the target service in the first data packet with the identification information corresponding to the target service instance.

In a possible implementation, after the determining the target service instance corresponding to the target service, the method further includes: adding, to an Internet Protocol version 6 IPv6 extension header of the first data packet, the identification information corresponding to the target service instance.

In a possible implementation, the IPv6 extension header of the data packet includes a destination options header, and the destination options header includes option content carrying the identification information.

In a possible implementation, the IPv6 extension header of the data packet includes a segment routing header, the segment routing header includes a type-length-value TLV, and the TLV includes the identification information corresponding to the target service instance.

In a possible implementation, the IPv6 extension header of the data packet includes a segment routing header, the segment routing header includes a segment list, and the identification information corresponding to the target service instance is located at an end of a path indicated by the segment list.

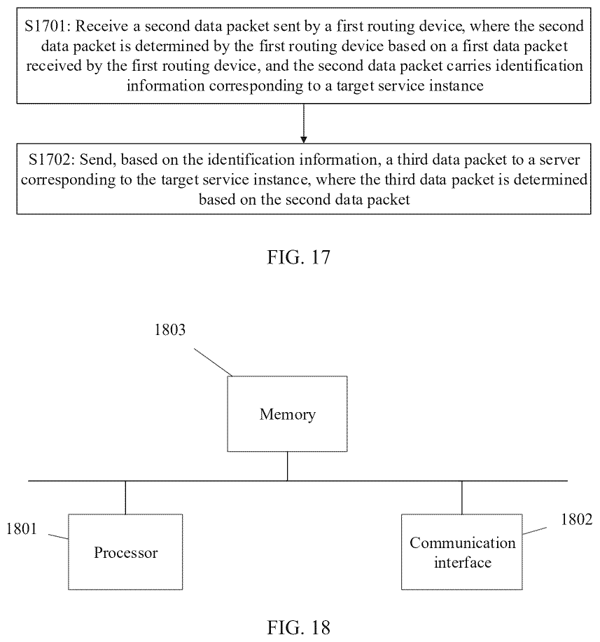

An embodiment of this application further provides a service processing method in compute first networking. The method is applied to a second routing device, and the second routing device may be an egress routing device. FIG. 17 is a schematic flowchart of yet another service processing method according to an embodiment of this application. As shown in FIG. 17, the method includes the following steps.

S1701: Receive a second data packet sent by a first routing device, where the second data packet is determined by the first routing device based on a first data packet received by the first routing device, and the second data packet carries identification information corresponding to a target service instance. The identification information corresponding to the target service instance may be a binding identifier BID.

S1702: Send, based on the identification information, a third data packet to a server corresponding to the target service instance, where the third data packet is determined based on the second data packet.

In a possible implementation, before the sending the third data packet to the server corresponding to the target service instance, the method further includes at least one of the following: parsing a destination options header of the second data packet to obtain option content carried by the destination options header, and determining the identification information based on the option content; parsing a segment routing header of the second data packet to obtain a type-length-value of the segment routing header, and determining the identification information based on the type-length-value; or parsing a segment routing header of the second data packet to obtain a segment list of the segment routing header, and determining the identification information based on a path indicated by the segment list.

In a possible implementation, before the receiving the second data packet sent by the first routing device, the method further includes: sending computing power and routing information to the first routing device, where the computing power and routing information is used to indicate a correspondence between a target service of the second data packet and one or more service instances, and the one or more service instances include the target service instance.

In a possible implementation, in a case that the target service corresponds to a plurality of service instances, the sending, based on the identification information, the third data packet to the server corresponding to the target service instance includes: determining, based on the identification information corresponding to the target service instance, the server corresponding to the target service instance from a plurality of servers corresponding to the plurality of service instances; and sending the third data packet to the server corresponding to the target service instance.

In a possible implementation, the second data packet includes tunnel information, and before the sending, based on the identification information, the third data packet to the server corresponding to the target service instance, the method further includes: decapsulating the tunnel information in the second data packet; and using the decapsulated packet as the third data packet.

An embodiment of this application further provides a service processing system, including a first routing device and a second routing device. The first routing device is configured to receive a first data packet, where the first data packet carries identification information corresponding to a target service requested by a user; determine a target service instance corresponding to the target service; and send a second data packet to a second routing device corresponding to the target service instance, where the second data packet is determined based on the first data packet, and the second data packet carries identification information corresponding to the target service instance. The second routing device is configured to receive the second data packet sent by the first routing device; and send, based on the identification information corresponding to the target service instance, a third data packet to a server corresponding to the target service instance, where the third data packet is determined based on the second data packet.

FIG. 18 is a schematic diagram of a structure of an electronic device according to an embodiment of this application.

The electronic device in this embodiment of this application may include a processor 1801. The processor 1801, as a control center of the device, can use various interfaces and lines to connect various parts of the device, and run or execute instructions stored in a memory 1803 and invoke data stored in the memory 1803. The processor 1801 may include one or more processing units. The processor 1801 may integrate an application processor and a modem processor. The application processor mainly processes an operating system, an application program, and the like. The modem processor mainly processes wireless communication. It may be understood that the modem processor may alternatively not be integrated in the processor 1801. In some embodiments, the processor 1801 and the memory 1803 may be implemented on a same chip. In some embodiments, the processor 1801 and the memory 1803 may also be implemented separately on separate chips.

The processor 1801 may be a general-purpose processor, for example, a central processing unit (CPU), a digital signal processor, an application-specific integrated circuit, a field programmable gate array or another programmable logic device, a discrete gate or a transistor logic device, or a discrete hardware component, and may implement or perform the methods, steps, and logical block diagrams disclosed in embodiments of this application. The general-purpose processor may be a microprocessor or any conventional processor or the like. The steps of the methods disclosed with reference to embodiments of this application may be directly performed and completed by a hardware processor, or may be performed and completed by using a combination of hardware in the processor and a software module.

In this embodiment of this application, the memory 1803 stores instructions that can be executed by at least one processor 1801, and at least one processor 1801 may be configured to perform, by executing the instructions stored in the memory 1803, the steps of the method disclosed in embodiments of this application.

As a non-volatile computer-readable storage medium, the memory 1803 may be configured to store non-volatile software programs, non-volatile computer-executable programs, and modules. The memory 1803 may include at least one type of storage medium, for example, may include a flash memory, a hard disk, a multimedia card, a memory card, a random access memory (Random Access Memory, RAM), a static random access memory (Static Random Access Memory, SRAM), a programmable read-only memory (Programmable Read Only Memory, PROM), a read-only memory (Read Only Memory, ROM), an electrically erasable programmable read-only memory (Electrically Erasable Programmable Read-Only Memory, EEPROM), a magnetic memory, a magnetic disk, an optical disc, or the like. The memory 1803 is but not limited to any medium that can be used to carry or store desired program code in a form of an instruction or a data structure and can be accessed by a computer. The memory 1803 in this embodiment of this application may alternatively be a circuit or any other apparatus that can implement a storage function, and is configured to store program instructions and/or data.

In this embodiment of this application, the apparatus may further include a communication interface 1802. The electronic device can transmit data through the communication interface 1802.

Based on the same inventive concept, an embodiment of this application further provides a computer-readable storage medium. The computer-readable storage medium may store instructions. When the instructions are run on a computer, the computer is enabled to perform the operation steps provided in the foregoing method embodiments. The computer-readable storage medium may be the memory 1803 shown in FIG. 18.

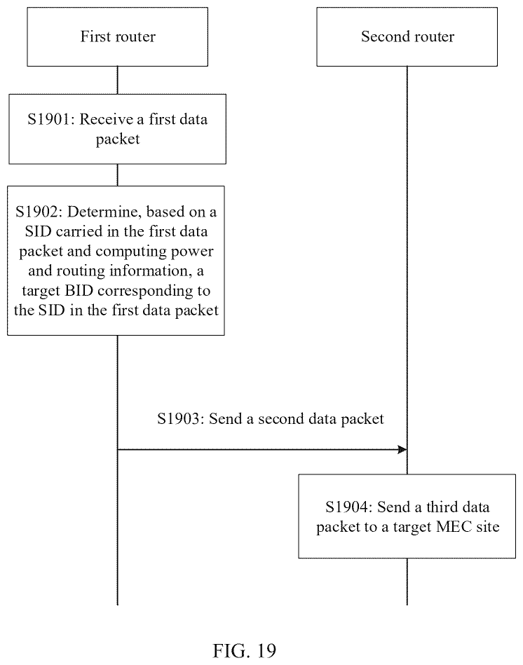

As shown in FIG. 19, an embodiment of this application further provides a service processing system, including a first router and a second router. The first router is configured to: receive a first data packet in S1901, where the first data packet carries a service identifier SID; determine, based on the service identifier SID and computing power and routing information, a target binding identifier BID corresponding to the SID in S1902, where a mobile edge computing MEC site corresponding to the target BID is a target MEC site; and send a second data packet to a second router corresponding to the target MEC site in S1903, where the second data packet is determined based on the first data packet, and the second data packet carries the target BID. The second router is configured to receive the second data packet sent by the first router, and send a third data packet to the target MEC site corresponding to the target BID in S1904, where the third data packet is determined based on the second data packet.

A person skilled in the art should understand that embodiments of this application may be provided as a method, a system, or a computer program product. Therefore, this application may use a form of a hardware-only embodiment, a software-only embodiment, or an embodiment with a combination of software and hardware. In addition, this application may use a form of a computer program product implemented on one or more computer-usable storage media (including but not limited to a disk memory, a CD-ROM, an optical memory, and the like) that include computer-usable program code.

This application is described with reference to the flowcharts and/or the block diagrams of the method, the device (system), and the computer program product according to this application. It should be understood that computer program instructions may be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the other programmable data processing device generate an apparatus for implementing a specific function in one or more procedures in the flowcharts and/or in one or more blocks in the block diagrams.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

Alternatively, these computer program instructions may be loaded onto a computer or another programmable data processing device, so that a series of operations and steps are performed on the computer or the other programmable device, to generate computer-implemented processing. Therefore, the instructions executed on the computer or the other programmable device provide steps for implementing a specific function in one or more procedures in the flowcharts and/or in one or more blocks in the block diagrams.

Apparently, a person skilled in the art may make various changes and variations to this application without departing from the spirit and scope of this application. Therefore, this application is intended to cover these modifications and variations of this application provided that they fall within the protection scope defined by the following claims and equivalent technologies thereof.

What is claimed is:

1. A service processing method, applied to a first routing device, wherein the method comprises:
receiving a first data packet, wherein the first data packet carries identification information corresponding to a target service requested by a user;
determining a target service instance corresponding to the target service; and
sending a second data packet to a second routing device corresponding to the target service instance, wherein the second data packet is determined based on the first data packet, and the second data packet carries identification information corresponding to the target service instance.

2. The method according to claim 1, wherein before the determining the target service instance corresponding to the target service, the method further comprises:
receiving computing power and routing information sent by the second routing device, wherein the computing power and routing information is used to indicate a correspondence between the target service and one or more service instances, and the one or more service instances comprise the target service instance.

3. The method according to claim 1, wherein the first routing device is applied to compute first networking, the compute first networking comprises one or more second routing devices, the one or more second routing devices are connected to a plurality of servers, and the plurality of servers are configured to provide the target service; and
the determining the target service instance corresponding to the target service comprises:
determining computing power resource information of the plurality of servers and network parameter information of the one or more second routing devices; and
determining, based on the computing power resource information and the network parameter information, the target service instance corresponding to the target service from a plurality of service instances corresponding to the plurality of servers.

4. The method according to claim 1, wherein after the determining the target service instance corresponding to the target service, the method further comprises:
replacing the identification information corresponding to the target service in the first data packet with the identification information corresponding to the target service instance.

5. The method according to claim 1, wherein after the determining the target service instance corresponding to the target service, the method further comprises:
adding, to an Internet Protocol version 6 IPv6 extension header of the first data packet, the identification information corresponding to the target service instance.

6. The method according to claim 5, wherein the IPv6 extension header of the data packet comprises a destination options header, and the destination options header comprises option content carrying the identification information.

7. The method according to claim 5, wherein the IPv6 extension header of the data packet comprises a segment routing header, the segment routing header comprises a type-length-value TLV, and the TLV comprises the identification information corresponding to the target service instance.

8. The method according to claim 5, wherein the IPv6 extension header of the data packet comprises a segment routing header, the segment routing header comprises a segment list, and the identification information corresponding to the target service instance is located at an end of a path indicated by the segment list.

9. The method according to claim 1, wherein the first data packet comprises data and tunnel information.

10. A service processing method, applied to a second routing device, wherein the method comprises:
receiving a second data packet sent by a first routing device, wherein the second data packet is determined by the first routing device based on a first data packet received by the first routing device, and the second data packet carries identification information corresponding to a target service instance; and
sending, based on the identification information, a third data packet to a server corresponding to the target service instance, wherein the third data packet is determined based on the second data packet.

11. The method according to claim 10, wherein before the sending the third data packet to the server corresponding to the target service instance, the method further comprises at least one of the following:
parsing a destination options header of the second data packet to obtain option content carried by the destination options header, and determining the identification information based on the option content;
parsing a segment routing header of the second data packet to obtain a type-length-value of the segment routing header, and determining the identification information based on the type-length-value; or
parsing a segment routing header of the second data packet to obtain a segment list of the segment routing header, and determining the identification information based on a path indicated by the segment list.

12. The method according to claim 10, wherein before the receiving the second data packet sent by the first routing device, the method further comprises:
sending computing power and routing information to the first routing device, wherein the computing power and routing information is used to indicate a correspondence between a target service of the second data packet and one or more service instances, and the one or more service instances comprise the target service instance.

13. The method according to claim 12, wherein in a case that the target service corresponds to a plurality of service instances, the sending, based on the identification information, the third data packet to the server corresponding to the target service instance comprises:
determining, based on the identification information corresponding to the target service instance, the server corresponding to the target service instance from a plurality of servers corresponding to the plurality of service instances; and
sending the third data packet to the server corresponding to the target service instance.

14. The method according to claim 10, wherein the second data packet comprises tunnel information, and before the sending, based on the identification information, the third data packet to the server corresponding to the target service instance, the method further comprises:
decapsulating the tunnel information in the second data packet; and
using the decapsulated packet as the third data packet.

15. A computer-readable storage medium, wherein the computer-readable storage medium stores a program or instructions, and when the program or instructions are executed by a processor, the steps of the service processing method according to claim 1 are implemented.

16. A computer-readable storage medium, wherein the computer-readable storage medium stores a program or instructions, and when the program or instructions are executed by a processor, the steps of the service processing method according to claim 10 are implemented.

17. An electronic device, comprising a processor and a memory, wherein the memory stores a program or instructions capable of running on the processor, and when the program or instructions are executed by the processor, the steps of the service processing method according to claim 1 are implemented.

18. An electronic device, comprising a processor and a memory, wherein the memory stores a program or instructions capable of running on the processor, and when the program or instructions are executed by the processor, the steps of the service processing method according to claim 10 are implemented.

19. A service processing system, comprising:
a first routing device, configured to receive a first data packet, wherein the first data packet carries identification information corresponding to a target service requested by a user; determine a target service instance corresponding to the target service; and send a second data packet to a second routing device corresponding to the target service instance, wherein the second data packet is determined based on the first data packet, and the second data packet carries identification information corresponding to the target service instance; and
the second routing device, configured to receive the second data packet sent by the first routing device; and send, based on the identification information corresponding to the target service instance, a third data packet to a server corresponding to the target service instance, wherein the third data packet is determined based on the second data packet.
